(19) United States
(12) Patent Application Publication
(10) Pub. No.: US 2014/0376112 A1
(43) Pub. Date: Dec. 25, 2014

(54) WIDE-ANGLE IMAGING LENS ASSEMBLY WITH TWO LENSES

(71) Applicant: ABILITY OPTO-ELECTRONICS TECHNOLOGY CO., LTD, Taichung County (TW)

(72) Inventor: Chen-hung TSAI, Taichung (TW)

(73) Assignee: ABILITY OPTO-ELECTRONICS TECHNOLOGY CO., LTD, Taichung County (TW)

(21) Appl. No.: 13/970,832

(22) Filed: Aug. 20, 2013

(30) Foreign Application Priority Data
Jun. 20, 2013 (TW) 102211490

(51) Int. Cl. G02B 13/00

(52) U.S. Cl. CPC G02B 13/003
USPC 359/717

(57) ABSTRACT

A wide-angle imaging lens assembly comprises a fixing diaphragm and an optical set including two lenses. An arranging order from an object side to an image side is: a first lens with a positive refractive power, a convex surface directed toward the object side, and a convex surface directed toward the image side; and a second lens with a positive refractive power, a concave surface directed toward the object side, and a convex surface directed toward the image side. Two surfaces of the two lenses are aspheric. The fixing diaphragm is disposed between an object and the second lens. By the concatenation between the lenses and the adapted curvature radius, thickness/interval, refractivity, and Abbe numbers, the assembly attains a big diaphragm with ultra-wide-angle, a shorter height, and a better optical aberration.

The current application claims a foreign priority to the patent application of Taiwan No. 102211490 filed on Jun. 20, 2013.

### BACKGROUND OF THE INVENTION

1. Field of the Invention

The present invention relates to a wide-angle imaging lens assembly with two lenses, in particular to a lens structure attaining a shorter height and a high resolution by curvature, interval and optical parameter between each lens.

2. Description of the Related Art

The conventional lens structure adopts an image display lens assembly which is applied to smart phone, tablet PC, cell phone, notebook, and webcam. The electronic products are developed to become lighter, thinner, shorter, and smaller and provide with higher efficiency. A video sensor of the image display lens assembly, such as Charge Coupled Device (CCD) or Complementary Metal Oxide Semiconductor (CMOS), is also developed for more pixels, so the lens structure is ceaselessly developed to be provided with compactness and higher resolution.

Therefore, the present invention is disclosed in accordance with a lens structure with multi-lens for a demand of the development of the image display lens assembly, especially to an imaging lens assembly of a lens structure with at least two lenses.

### SUMMARY OF THE INVENTION

In view of the conventional lens structure that has big volume and lack of efficiency, a wide-angle imaging lens assembly with two lenses is disclosed.

It is an object of the present invention to provide a wide-angle imaging lens assembly with two lenses, which comprises a fixing diaphragm and an optical set. The optical set includes a first lens and a second lens. An arranging order thereof from an object side to an image side is: the first lens having a lens with a positive refractive power, a convex surface directed toward the object side, and a convex surface directed toward the image side, and two surfaces of the first lens are aspheric; the second lens having a lens with a positive refractive power, a concave surface directed toward the object side, and a convex surface directed toward the image side, and two surfaces of the second lens are aspheric; and the diaphragm disposed between an object and the second lens.

The imaging lens assembly includes at least one inflection point from an optical axis to an end point of the aspheric surfaces is defined on the second lens directed toward the object side.

The imaging lens assembly satisfies the following conditional expression: 0.8<f1/f2<1.3. The f1 and f2 are defined as the focal lengths of the first lens and the second lens, respectively.

A shape of the aspheric surface satisfies a formula of:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + …$$

The z is defined as a position value about a location at a height of h along a direction of the optical axis referring to a surface top point. The k is defined as a conic constant. The c is a reciprocal of a radius of a curvature. The A, B, C, D, E, etc. are defined as high-order aspheric surface coefficients.

The present invention is characterized in that a lens structure attains a big diaphragm with ultra-wide-angle, a shorter height, and a high resolution by curvature, interval, and optical parameter between each lens.

### BRIEF DESCRIPTION OF THE DRAWINGS

FIG. 1 is a schematic view showing an optical structure of a first preferred embodiment of the present invention;

FIG. 2 is a schematic view showing an astigmatic aberration of the first preferred embodiment of the present invention;

FIG. 3 is a schematic view showing a distorted aberration of the first preferred embodiment of the present invention;

FIG. 4 is a schematic view showing a spherical aberration of the first preferred embodiment of the present invention;

FIG. 5 is a schematic view showing an optical structure of a second preferred embodiment of the present invention;

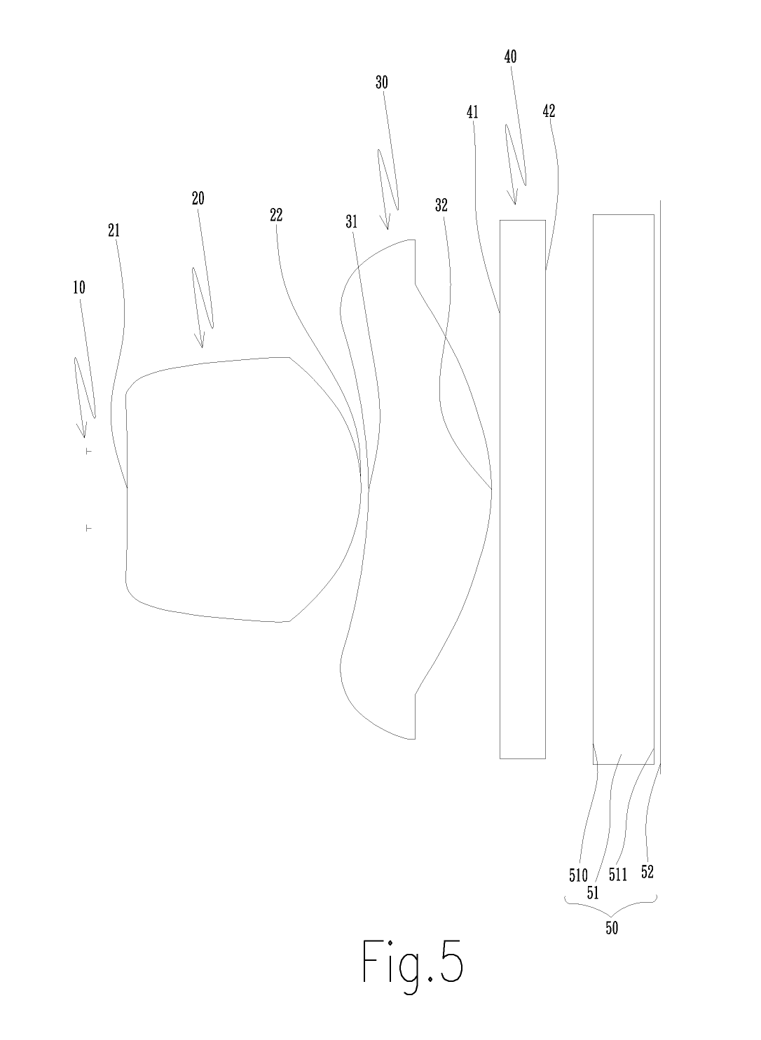

FIG. 6 is a schematic view showing an astigmatic aberration of the second preferred embodiment of the present invention;

FIG. 7 is a schematic view showing a distorted aberration of the second preferred embodiment of the present invention; and

FIG. 8 is a schematic view showing a spherical aberration of the second preferred embodiment of the present invention.

### DETAILED DESCRIPTION OF THE PREFERRED EMBODIMENTS

Before describing in detail, it should note that the like elements are denoted by the similar reference numerals throughout disclosure.

The present invention provides an imaging lens structure, in particular to a lens structure attaining a big diaphragm with ultra-wide-angle, a shorter height, and a high resolution by a curvature, an interval, and an optical parameter between each lens.

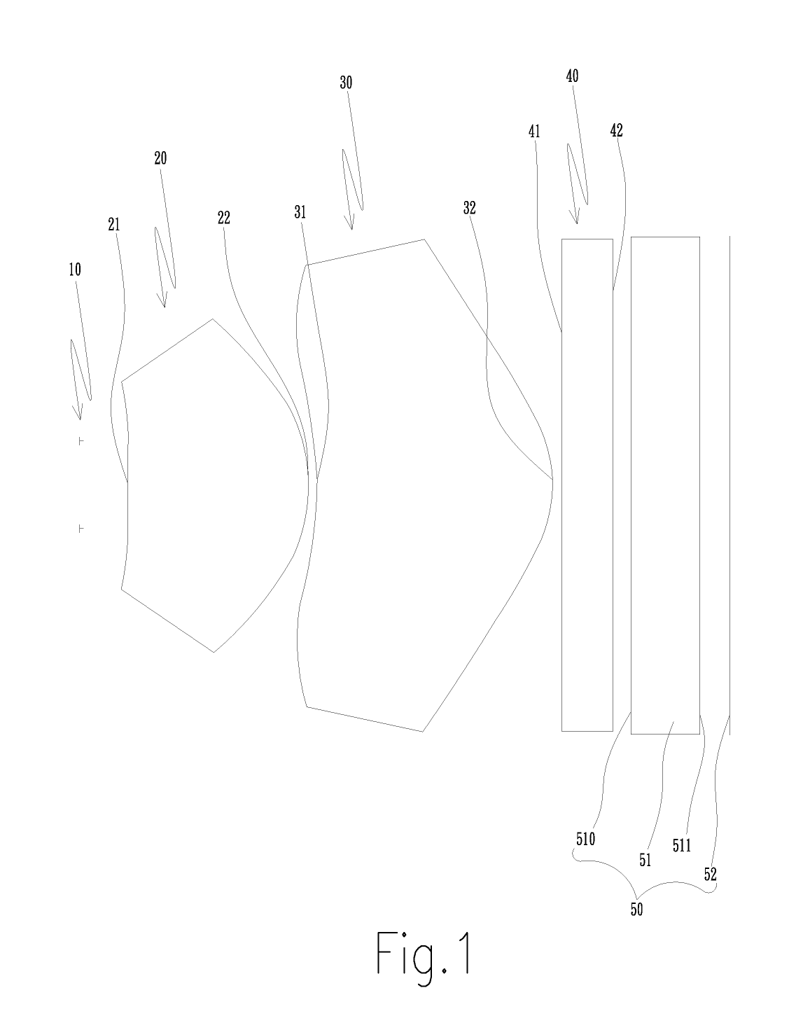

Referring to FIG. 1, a schematic view of an optical structure of a wide-angle imaging lens assembly with two lenses is shown. The structure of the imaging lens comprises a fixing diaphragm 10 and an optical set. The optical set includes a first lens 20 and a second lens 30. An arranging order thereof from an object side to an image side is: the first lens 20 with a positive refractive power, a convex surface directed toward the object side, and a convex surface directed toward the image side, and two surfaces of the first lens are aspheric; the second lens 30 with a positive refractive power, a concave surface directed toward the object side, a convex surface directed toward the image side, two surfaces of the second surface are aspheric, and at least one inflection point defined from an optical axis to an end point of the aspheric surfaces on the second surface 30 directed toward the object side; the fixing diaphragm 10 disposed between an object and the second lens 30; a filter unit 40 filtering light with specific wave length and being adopted by an infrared stopping filter unit applied to a visible light image or an infrared band-pass unit applied to an infrared imaging; and an image sensor 50 (an imaging surface side) used for receiving a digital signal transformed by the filter unit. The image sensor 50 includes a flat protection lens 51 and a video sensor 52. The video sensor 52 is preferably adopted by Charge Coupled Device (CCD) or Complementary Metal Oxide Semiconductor (CMOS).

The imaging lens assembly satisfies the following conditional expression: 0.8<f1/f2<1.3. The f1 and f2 are defined as focal lengths of the first lens and the second lens, respectively.

The first lens 20 includes a first surface 21 facing an object side and a second surface 22 facing the imaging surface side. The first surface 21 is defined as a convex surface opposite to the object side. The second surface 22 is defined as a convex surface opposite to the imaging surface side. The second lens 30 includes a third surface 31 facing the object side and a fourth surface 32 facing the imaging surface side. The third surface 31 is defined as a concave surface opposite to the object side. The fourth surface 32 is defined as a convex surface opposite to the imaging surface side. Two surfaces of the first lens 20 and the second lens 30 are aspheric, thereby correcting the spherical aberration and the image aberration for having a characteristic of low common difference sensitivity.

A shape of the aspheric surface of the imaging lens assembly satisfies a formula of:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + …$$

The z is defined as a position value about a location at a height of h along a direction of the optical axis referring to a surface top point. The k is defined as a conic constant. The c is a reciprocal of a radius of a curvature. The A, B, C, D, E, etc. are defined as high-order aspheric surface coefficients.

In an ultra-wide-angle micro-optical image capturing device of the present invention, the fixing diaphragm 10 is disposed between the object and the first lens 20 for getting an incident beam. The first lens 20 and the second lens 30 are adopted by lenses with positive refractive power. The first lens 20 adopts the first surface 21 convexly defined toward the object side for assembling the external incident beam with ultra-wide-angle so as to keep the beam on the second surface 22 of the first lens 20, thereby presenting a function of the aspheric surface, correcting the aberration, reducing the common difference sensitivity, and rendering the device have ultra-wide-angle with an image-capture angle over 85°. The third surface 31 defined on the second lens 30 as a concave surface opposite to the object side is then expanded and radiated, so that the beam is able to be spread on the fourth surface 32 of the second lens 30 with a larger dimension. That is to say, the incident beam is expanded and radiated by the third surface 31 so as to be spread on the fourth surface 32 with a larger dimension, thereby presenting the function of aspheric surface, correcting the aberration, and reducing common difference sensitivity.

The aspheric surface not only corrects the spherical aberration and the image aberration but also reduces the full length of the lens optical system. The first lens 20 and the second lens 30 are preferably adopted by plastic, which is conducive to eliminate the aberration and reduce the weight of the lens. The entire optical system consists of two plastic lenses and benefits a mass production. The optical system also provides with the low common difference sensitivity to meet a requirement of the mass production.

By the concatenation between the above-mentioned surfaces of lenses and the adapted curvature radius, thickness/interval, refractivity, and Abbe numbers, the assembly attains a big diaphragm with ultra-wide-angle, a shorter height, and a better optical aberration.

### First Preferred Embodiment of the Present Invention

Due to the above-mentioned technique of the present invention, it is able to be practiced in accordance with the following values:

Basic lens data of the first preferred embodiment

| | | Curvature radius | Thickness/Interval | Refractivity | Abbe number |
|---|---|---|---|---|---|
| Surfaces | | (Radius) | (Thickness) | (Nd) | (Vd) |
| Fixing diaphragm 10 | | ∞ | 0.29 | | |
| First lens 20 | First surface 21 | 21.38 | 1.03 | 1.58500 | 29.90000 |
| | Second surface | −0.96 | 0.05 | | |
| | 22 | | | | |
| Second lens | Third surface | −1.89 | 1.35 | 1.58500 | 29.90000 |
| 30 | 31 | | | | |
| | Fourth surface | −0.68 | 0.06 | | |
| | 32 | | | | |
| Filter unit 40 | Fifth surface 41 | ∞ | 0.30 | 1.516800 | 64.167336 |
| | Sixth surface 42 | ∞ | 0.23 | | |
| Flat protection | Seventh surface | ∞ | 0.40 | 1.516800 | 64.167336 |
| lens 51 | 510 | | | | |
| | Eighth surface | ∞ | 0.04 | | |
| | 511 | | | | |

The filter unit 40 has a thickness of 0.3 mm. A thickness of the flat protection lens 51 is 0.4 mm.

The A, B, C, D, and E are defined as high-order aspheric surface coefficients.

The values of quadratic surface coefficient of the aspheric surface of the first preferred embodiment are listed as follows:

The first surface 21 (k=−200):

A: −0.9526660

B: 1.6119010

C: 3.1717149

D: −16.864665

E: 22.826107

The second surface 22 (k=−0.29):

A: −0.0436547

B: −0.0878423

C: 0.0668450

D: 0.3991920

E: −0.2277371

The third surface 31 (k=0.85):

A: 0.1107665

B: 0.1346585

C: −0.0292895

D: −0.0368052

E: 0.0166888

The fourth surface 32 (k=−3.50):

A: −0.2896172

B: 0.5504785

C: −0.4639722

D: 0.1839356

E: −0.0278005

According to the above-mentioned values, the related exponent of performance of the micro-image capturing lens is: f1=1.64 mm; f2=1.33 mm; f1/f2=1.23.

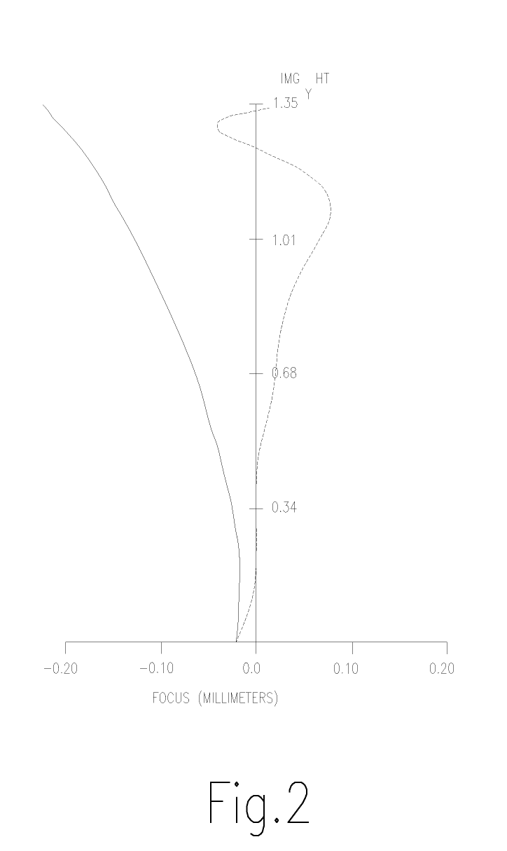

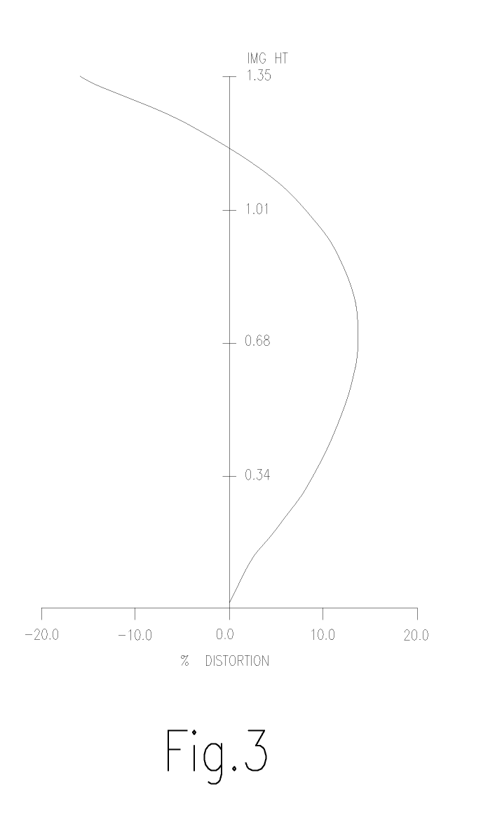

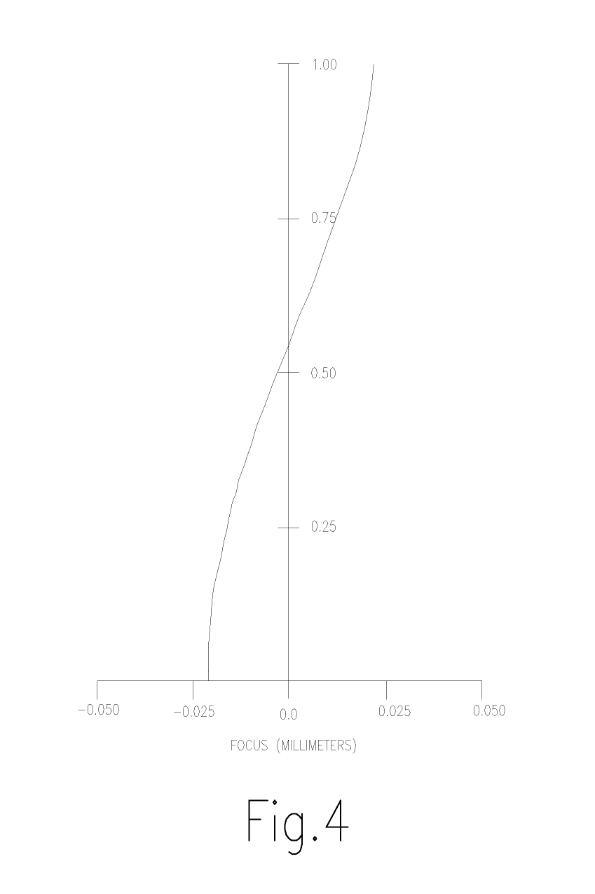

Referring to FIG. 2, a schematic view of an astigmatic aberration of the first preferred embodiment of the present invention is shown. Referring to FIG. 3, a schematic view of a distorted aberration of the first preferred embodiment of the present invention is shown. Referring to FIG. 4, a schematic view of a spherical aberration of the first preferred embodiment of the present invention is shown. The measured astigmatic aberration, distorted aberration, and spherical aberration are in the standard scope and have a good optical performance and imaging quality according to the above-mentioned figures.

### Second Preferred Embodiment of the Present Invention

Due to the above-mentioned technique of the present invention, it is able to be practiced in accordance with the following values:

Basic lens data of the second preferred embodiment

| | | Curvature radius | Thickness/Interval | Refractivity | Abbe number |
|---|---|---|---|---|---|
| Surfaces | | (Radius) | (Thickness) | (Nd) | (Vd) |
| Fixing diaphragm 10 | | ∞ | 0.26 | | |
| First lens 20 | First surface 21 | 9.60 | 1.53 | 1.58500 | 29.90000 |
| | Second surface | −0.96 | 0.05 | | |
| | 22 | | | | |
| Second lens | Third surface 31 | −1.53 | 0.8 | 1.58500 | 29.90000 |
| 30 | Fourth surface | −0.72 | 0.05 | | |
| | 32 | | | | |
| Filter unit 40 | Fifth surface 41 | ∞ | 0.30 | 1.516800 | 64.167336 |
| | Sixth surface 42 | ∞ | 0.31 | | |
| Flat protection | Seventh surface | ∞ | 0.40 | 1.516800 | 64.167336 |
| lens 51 | 510 | | | | |
| | Eighth surface | ∞ | 0.04 | | |
| | 511 | | | | |

The filter unit 40 has a thickness of 0.3 mm. A thickness of the flat protection lens 51 is 0.4 mm.

The A, B, C, D, E, F and G are defined as high-order aspheric surface coefficients.

The values of quadratic surface coefficient of the aspheric surface of the second preferred embodiment are listed as follows:

The first surface 21 (k=−29.74):

A: −0.8460894

B: 3.0092862

C: −7.0484987

D: 9.1135984

E: 2.7944417

F: −8.9414881

G: 9.0653127

The second surface 22 (k=−0.66):

A: −0.0852338

B: −0.1847909

C: 0.6000429

D: −0.7269254

E: 0.3243073

F: −0.01225044

G: 0.0059193

The third surface 31 (k=−172.55):

A: −0.1782629

B: 0.0840052

C: −0.0058281

D: 0.0123393

E: 0.0008514

F: −0.0048850

G: 0.0011975

The fourth surface 32 (k=−17.81):

A: −0.1963689

B: 0.2001824

C: −0.1813738

D: 0.0818492

E: 0.0136069

F: −0.0262297

G: 0.0068475

According to the above-mentioned values, the related exponent of performance of the micro-image capturing lens is: f1=1.61 mm; f2=1.76 mm; f1/f2=0.92.

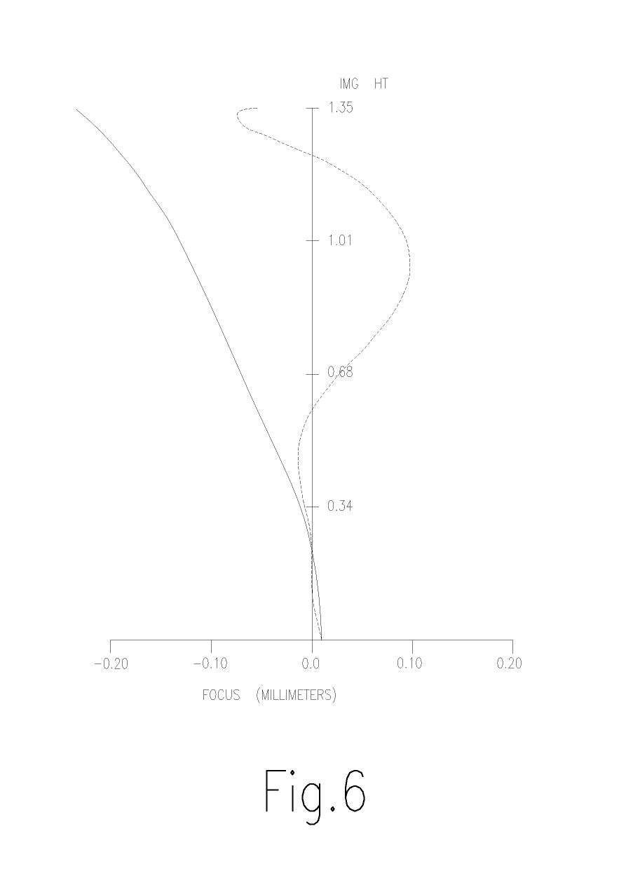

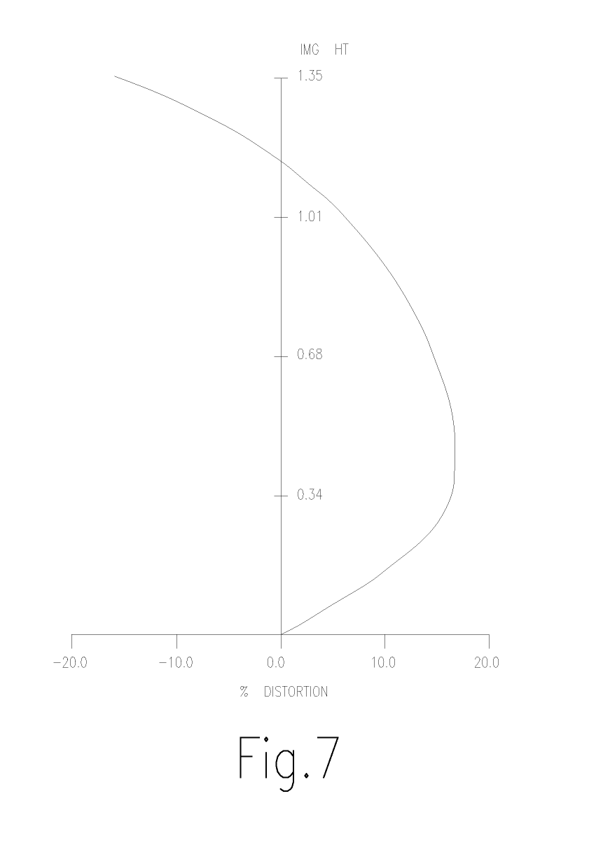

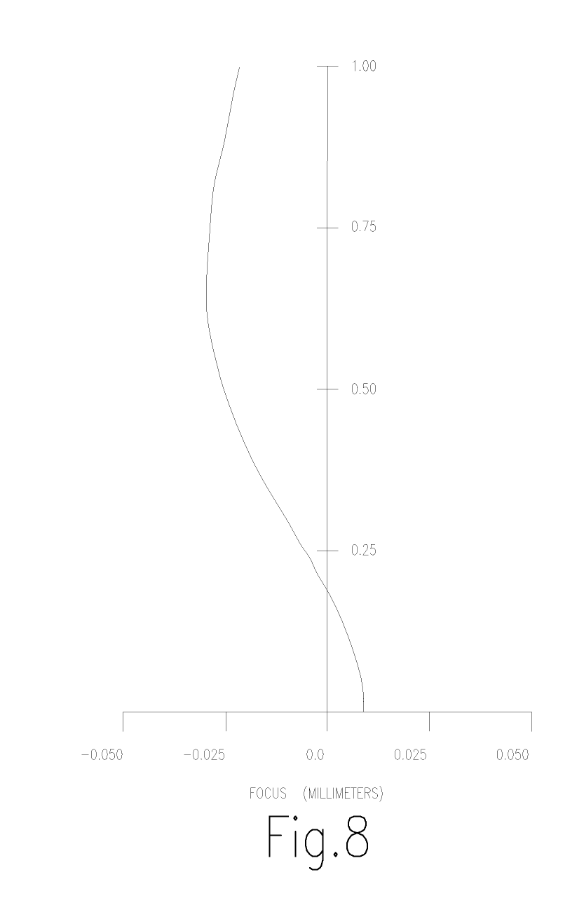

Referring to FIG. 6, a schematic view of an astigmatic aberration of the second preferred embodiment of the present invention is shown. Referring to FIG. 7, a schematic view of a distorted aberration of the second preferred embodiment of the present invention is shown. Referring to FIG. 8, a schematic view of a spherical aberration of the second preferred embodiment of the present invention is shown. The measured astigmatic aberration, distorted aberration, and spherical aberration are in the standard scope and have a good optical performance and imaging quality according to the above-mentioned figures.

The micro-optical image capturing device utilizes two aspheric lenses with positive refractive power and the filter unit 40 which filters a light with infrared wave length and allows the visible light with the required wave length. The filter unit 40 is preferably adopted by an infrared stopping filter unit applied to the visible light image or an infrared band-pass unit applied to an infrared imaging.

By making use of the aspheric surface that corrects the aberration and reduces the common difference sensitivity, not only the aberration is corrected but also the full length of the lens optical system is reduced. Further, the device provides with a ultra-wide-angle with an image capturing angle over 85°. The first and second lenses are preferably adopted by plastic, which is conducive to eliminate the aberration and reduce the weight of the lens. The optical system consists of two plastic lenses and provides with the low common difference sensitivity. The optical system is also easy to be manufactured and assembled and benefits a mass production. Furthermore, the optical system provides with a fine imaging quality to meet the requirement of miniaturizing the portable image capturing products.

While we have shown and described the embodiment in accordance with the present invention, it should be clear to those skilled in the art that further embodiments may be made without departing from the scope of the present invention.

I claim:

1. A wide-angle imaging lens assembly with two lenses comprising a fixing diaphragm and an optical set; said optical set including a first lens and a second lens, an arranging order thereof from an object side to an image side being:
said first lens having a lens with a positive refractive power, a convex surface directed toward said object side, and a convex surface directed toward said image side; two surfaces of said first lens being aspheric;
said second lens having a lens with a positive refractive power, a concave surface directed toward said object side, and a convex surface directed toward said image side; two surfaces of said second lens being aspheric; and
said diaphragm disposed between an object and said second lens.

2. The wide-angle imaging lens assembly with two lenses as claimed in claim 1, wherein at least one inflection point from an optical axis to an end point of said aspheric surfaces is defined on said second lens directed toward said object side.

3. The wide-angle imaging lens assembly with two lenses as claimed in claim 1 further satisfying the following conditional expression 0.8<f1/f2<1.3, wherein said f1 and f2 are defined as focal lengths of said first and said second lenses, respectively.

4. The wide-angle imaging lens assembly with two lenses as claimed in claim 1, wherein a shape of said aspheric surface satisfies a formula of:
$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + …$$
wherein said z is defined as a position value about a location at a height of h along a direction of said optical axis referring to a surface top point, said k is defined as a conic constant, said c is a reciprocal of a radius of a curvature, and said A, B, C, D, E, etc. are defined as high-order aspheric surface coefficients.
